(19) United States
(12) Patent Application Publication
(10) Pub. No.: US 2010/0285829 A1
(43) Pub. Date: Nov. 11, 2010

(54) ORTHOGONAL FREQUENCY DIVISION MULTIPLEXING SYSTEM AND METHOD FOR PREAMBLE POWER CONTROL OF THE ORTHOGONAL FREQUENCY DIVISION MULTIPLEXING SYSTEM

(75) Inventors: Keun Moo Lee, Seongnam-si (KR); Hyung Won Kim, Seongnam-si (KR)

Correspondence Address: CANTOR COLBURN, LLP, 20 Church Street, 22nd Floor, Hartford, CT, 06103, US

(73) Assignee: XRONET CORPORATION, Seongnam-si (KR)

(21) Appl. No.: 12/810,930

(22) PCT Filed: Dec. 22, 2008
(86) PCT No.: PCT/KR08/07579

§ 371 Date: Jun. 28, 2010

(30) Foreign Application Priority Data
Dec. 29, 2007 (KR) 10-2007-0141112

(51) Int. Cl. H04W 52/04; H04L 27/28

(52) U.S. Cl. 455/522; 375/260

(57) ABSTRACT

An orthogonal frequency division multiplexing (OFDM) system and a method of controlling preamble power of the OFDM system are provided. The method includes detecting a present preamble power of a certain base station among a plurality of base stations and a preamble influence factor of the certain base station; detecting a preamble influence factor of at least one neighboring base station of the certain base station; and determining a new preamble power of the certain base station based on at least one among the present preamble power, the preamble influence factor of the certain base station, and the preamble influence factor of the at least one neighboring base station.

### TECHNICAL FIELD

The present invention relates to an orthogonal frequency division multiplexing (OFDM) or orthogonal frequency division multiple access (OFDMA) system, and more particularly, to a method and system for controlling preamble power at a base station of an OFDM system.

### BACKGROUND ART

When a traffic load is not uniform in a wireless network system for mobile communication, decrease of the entire capacity of the wireless network system is unavoidable. For instance, when an excessive load occurs in a particular cell while there is no traffic loads in adjacent cells because there are just a few users, the capacity that can be provided through an entire wireless network cannot be serviced satisfactorily. In order to minimize the capacity loss caused by uneven distribution of user traffic load, it is necessary to vary a cell service area according to a traffic load.

Meanwhile, when data is transmitted from a base station to a mobile station in an orthogonal frequency division multiplexing (OFDM)/orthogonal frequency division multiple access (OFDMA) system, a preamble is always transmitted first. For instance, in a downlink structure of an 802.16e OFDM system, a preamble always comes at the beginning of a transmitting symbol. The preamble fundamentally has a scrambling pattern for identifying the base station. The mobile station selects a cell using the preamble. Also, received signal strength indication (RSSI) and carrier to interference plus noise ratio (CINR) estimation necessary for hand-off or hand-over are performed using the preamble. As mentioned above, the preamble is important when a terminal selects a base station, and therefore, it is very significant to adaptively and appropriately use the power of the preamble.

In conventional OFDM systems (e.g., 802.16e OFDMA systems), however, a pream ble is always transmitted with a predetermined power. The preamble is boosted to be 9 db higher than a data subcarrier and differently located at a frequency domain according to a segment. Since the OFDMA systems have the fixed preamble power, a terminal s selection of a base station and hand-off is performed regardless of a user traffic load. As a result, the entire performance of a communication system cannot be optimized when traffic imbalance occurs among base stations.

### DISCLOSURE OF INVENTION

### Technical Problem

The present invention provides an orthogonal frequency division multiplexing (OFDM) system and method for increasing performance of a communication system by adaptively controlling preamble power according to an environment of a base station.

### Advantageous Effects

According to the present invention, the preamble power of an OFDM system can be adaptively changed according to a control signal of a control station.

In particular, hand-over is automatically performed by controlling the preamble power of a particular base station according to environmental factors (e.g., traffic loads) of the particular base station and its neighboring base stations, so that traffic loads are evenly distributed to cells. Due to the uniform distribution of the traffic loads, the capacity of an entire wireless network can be optimized.

### BRIEF DESCRIPTION OF DRAWINGS

The drawings referred to in the detailed description of the invention will become more apparent by briefly explaining the drawings:

FIG. 1 illustrates the schematic structure of an OFDM system according to some embodiments of the present invention; and

FIG. 2 is a schematic flowchart of a method of controlling preamble power of an OFDM system according to some embodiments of the present invention.

### BEST MODE FOR CARRYING OUT THE INVENTION

According to an aspect of the present invention, there is provided a method of controlling preamble power of an orthogonal frequency division multiplexing (OFDM) system including a plurality of base stations and a control station controlling the plurality of base stations. The method includes detecting a present preamble power of a certain base station among the plurality of base stations and a preamble influence factor of the certain base station; detecting a preamble influence factor of at least one neighboring base station of the certain base station; and determining a new preamble power of the certain base station based on at least one among the present preamble power, the preamble influence factor of the certain base station, and the preamble influence factor of the at least one neighboring base station. At least one of the preamble influence factor of the certain base station and the preamble influence factor of the at least one neighboring base station may include a traffic load of the corresponding base station.

The detecting the preamble influence factor of the at least one neighboring base station of the certain base station may include determining the at least one neighboring base station based on a neighboring base station list including information about neighboring base stations corresponding to the certain base station and detecting the preamble influence factor of the determined at least one neighboring base station.

The detecting the preamble influence factor of the determined at least one neighboring base station may include applying a predetermined weighting factor to the preamble influence factor of each of the at least one neighboring base station. The new preamble power of the certain base station may be determined by

Pwr_{new}(i)=(1−μ)·Pwrₚᵣₑ(i)+μ·Pwrₙₒₘᵢₙₐₗ·TLₒₜₕₑᵣ(i)/TL_{self}(i)

where Pwr_{new} is the new preamble power, Pwr_{new} is the present preamble power, Pwrₙₒₘᵢₙₐₗ is a basic preamble power, TLₒₜₕₑᵣ is a traffic load of neighboring base stations, TL_{self} is a traffic load of the certain base station, “μ” is a change sensitivity of a preamble, and “i” is an index of each base station.

When the new preamble power is greater than a maximum power, the new preamble power of the certain base station may be determined to be the maximum power. When the new preamble power is less than a minimum power, the new preamble power of the certain base station may be determined to be the minimum power. The method may be stored in a computer readable recording medium.

According to another aspect of the present invention, there is provided an OFDM system including a plurality of base stations and a control station configured to control preamble power of the base stations. The control station receives a present preamble power of the certain base station and a preamble influence factor of the certain base station from the certain base station; detects a preamble influence factor of at least one neighboring base station of the certain base station; determines a new preamble power of the certain base station based on at least one among the present preamble power, the preamble influence factor of the certain base station, and the preamble influence factor of the at least one neighboring base station; and transmits a control signal to the certain base station.

The control station may determine the at least one neighboring base station of the certain base station based on a neighboring base station list including information about neighboring base stations corresponding to the certain base station and detect the preamble influence factor of the determined at least one neighboring base station.

The control station may apply a predetermined weighting factor to the preamble influence factor of each of the at least one neighboring base station and detect the preamble influence factor of the at least one neighboring base station.

### MODE FOR THE INVENTION

The attached drawings for illustrating preferred embodiments of the present invention are referred to in order to gain a sufficient understanding of the present invention, the merits thereof, and the objectives accomplished by the implementation of the present invention. It will be understood that when an element is referred to as “transmitting” data to another element, it can directly transmit the data to the other element or intervening elements may be present. In contrast, when an element is referred to as “directly transmitting” data to another element, there are no intervening elements present.

Hereinafter, the present invention will be described in detail by explaining preferred embodiments of the invention with reference to the attached drawings. Like reference numerals in the drawings denote like elements.

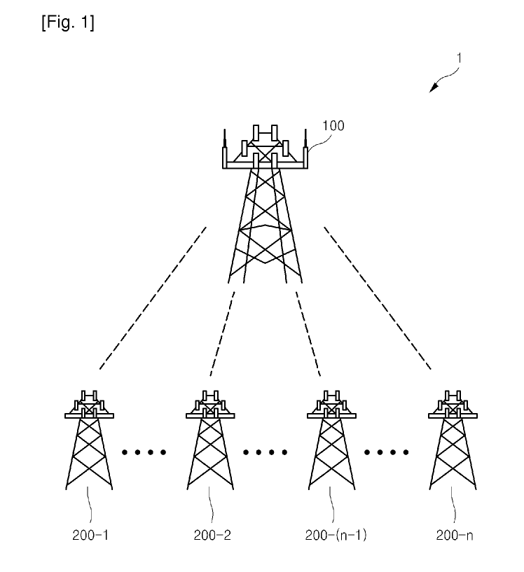

FIG. 1 illustrates the schematic structure of an orthogonal frequency division multiplexing (OFDM) system 1 according to some embodiments of the present invention. The OFDM system 1 includes a plurality of base stations 200-1 through 200-n and a control station 100 which controls the base stations 200-1 through 200-n. Here, the OFDM system 1 may comprehend an orthogonal frequency division multiple access (OFDMA) system.

Each of the base stations 200-1 through 200-n may transmit and receive data necessary for communication of a mobile station existing in a corresponding cell. The cell may be divided into a plurality of (e.g., three) sectors. Each of the base stations 200-1 through 200-n may separately transmit a preamble to each of the sectors during a downlink. Accordingly, each of the base stations 200-1 through 200-n may separately control the plurality of sectors.

The control station 100 may communicate with each of the base stations 200-1 through 200-n to control the base stations 200-1 through 200-n. In particular, in order to control preamble power according to some embodiments of the present invention, the control station 100 may transmit a control signal to each of the base stations 200-1 through 200-n. Each of the base stations 200-1 through 200-n receiving the control signal may adjust preamble power according to the control signal and transmit a preamble with the adjusted power to a mobile station in a cell or a sector included in the cell.

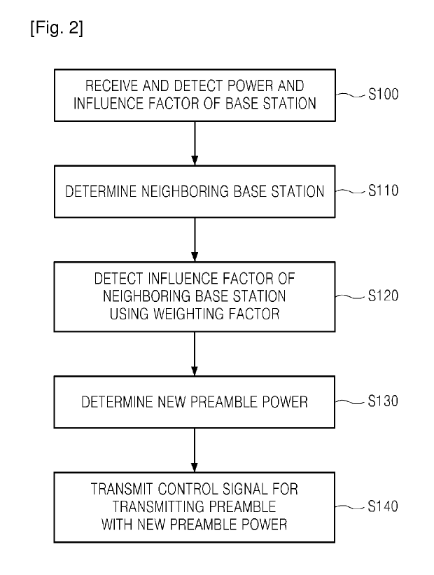

FIG. 2 is a schematic flowchart of a method of controlling preamble power of an OFDM system according to some embodiments of the present invention. Referring to FIGS. 1 and 2, the control station 100 may receive and detect information about a present preamble power of a certain base station (e.g., the base station 200-1) among the plurality of the base stations 200-1 through 200-n and information about a preamble influence factor of the base station 200-1 in operation S100. In other words, the control station 100 may receive information about a power value of a present preamble that the certain base station 200-1 transmits to a mobile station and information about a traffic load of the base station 200-1.

The preamble influence factor may comprehend all parameters of the OFDM system that can be considered when determining a preamble power. In the current embodiments of the present invention, the preamble influence factor is a traffic load of each base station, but the present invention is not restricted to these embodiments. Thereafter, the control station 100 may detect the preamble influence factor of at least one neighboring base station of the certain base station 200-1. The at least one neighboring base station may include all of base stations that may influence a cell corresponding to the certain base station 200-1. For instance, a base station corresponding to a cell adjacent to the cell corresponding to the certain base station 200-1 may be a neighboring base station of the certain base station 200-1.

When the size of a cell corresponding to the certain base station 200-1 is decreased, a mobile station dismissed from the decreased cell may be handed over to a cell corresponding to an adjacent base station (e.g., 200-2) of the certain base station 200-1. Accordingly, the adjacent base station 200-2 may be a neighboring base station of the certain base station 200-1. The certain base station 200-1 may have a plurality of neighboring base stations, which may exert different influences on the certain base station 200-1. For instance, the neighboring base stations may exert different influences on the certain base station 200-1 according to a beam pattern of an antenna of the certain base station 200-1 or each neighboring base station or a distance between the certain base station 200-1 and each neighboring base station.

Consequently, the preamble influence factor of the at least one neighboring base station may comprehend all of preamble influence factors that may occur in all base stations that may influence the certain base station 200-1. Meanwhile, the control station 100 may determine the at least one neighboring base station based on a neighboring base station list stored in a specified storage unit (not shown) of the control station 100 in operation S110 in order to detect the preamble influence factor of the at least one neighboring base station.

The neighboring base station list may include information about a neighboring base station that may influence to each base station. Accordingly, the control station 100 may obtain information about a neighboring base station of the certain base station 200-1 from the neighboring base station list.

As described above, since influences exerted on the certain base station 200-1 by the at least one neighboring base station may be different, information about a weighting factor (referred to as weighting factor information) indicating the degree of an influence exerted on the certain base station 200-1 by each neighboring base station may also be stored in the control station 100. The at least one neighboring base station's preamble influence factor with the weighting factor may be expressed by Equation (1):

$${TL}_{other} ( i ) = {\sum }_{n = 1}^{N} {β}_{BSn} ( i ) {TL}_{BSn} \qquad ( 1 )$$

where TLₒₜₕₑᵣ is all preamble influence factor (e.g., a traffic load) of neighboring base other stations, BSn is the number of neighboring base stations, b_{BSn} is a weighting factor of each neighboring base station, and TLBSn is a preamble influence factor of each neighboring base station. The sum of all weighting factors is 1, which is expressed by Equation (2):

$${\sum }_{n = 1}^{N} {β}_{BSn} ( i ) = 1 \qquad ( 2 )$$

The weighting factor information may be stored in the neighboring base station list or in a separate file or storage unit. The control station 100 may finally detect the preamble influence factor of the at least one neighboring base station based on the weighting factor information in operation S120.

Thereafter, the control station 100 may determine a new preamble power of the certain base station 200-1 based on at least one among the present preamble power, the preamble influence factor of the certain base station 200-1, and the preamble influence factor TLₒₜₕₑᵣ (i) of the at least one neighboring base station in operation S130. The control station 100 may transmit to the certain base station 200-1 a control signal for allowing the certain base station 200-1 to transmit a preamble symbol with the new preamble power determined by the control station 100 in operation S140.

As a result, a preamble power is not fixed and may be expressed by a function of a present preamble power Pwrₚᵣₑ of the certain base station 200-1, a preamble influence factor (e.g., a traffic load) TL of the certain base station 200-1, and the preamble influence factor (e.g., a traffic load) TL of all neighboring base stations, which is expressed by Equation (3):

Pwr_{new}=function(Pwrₚᵣₑ,TL_{self},TLₒₜₕₑᵣ) (3)

In detail, methods by which the control station 100 may determine a new preamble power based on the present preamble power Pwr^{pre} of the certain base station 200-1, the preamble influence factor (e.g., a traffic load) TL_{self} of the certain base station 200-1, and the preamble influence factor (e.g., a traffic load) TLₒₜₕₑᵣ of all neighboring base stations may vary with embodiments of the present invention. For instance, the new preamble power may be determined by Equation (4):

Pwr_{new}(i)=(1−μ)·Pwrₚᵣₑ(i)+μ·Pwrₙₒₘᵢₙₐₗ·TLₒₜₕₑᵣ(i)/TL_{self}(i) (4)

where Pwr_{new} is the new preamble power after change, Pwrₚᵣₑ is the present preamble power before the change, Pwrₙₒₘᵢₙₐₗ is a basic preamble power, TLₒₜₕₑᵣ is the traffic load of neighboring base stations, TL_{self} is the traffic load of the certain base station 200-1, and “i” is an index of each base station. Here, a value of “μ” may be a variable that determines how much the new preamble power will be reflected as compared to the present preamble power. Accordingly, as the value of “μ” increases, the preamble power changes more quickly. In addition, as is seen from Equation (4), the preamble power increases as the traffic load of a self cell decreases and the traffic load of a neighboring cell increases.

For instance, when the traffic load of a self cell is small, a new preamble power is greater than a present preamble power according to Equation (4). Then, the size of the self cell is increased and the self cell can take over the traffic load of a neighboring cell. Contrarily, when the traffic load of the neighboring cell is small and the traffic load of the self cell is large, the new preamble power is less than the present preamble power. Then, the traffic load of the self cell can be handed over to the neighboring cell.

In addition, the certain base station 200-1 may have a minimum preamble power to function as a base station and may have a maximum preamble power.

In this case, a method by which the control station 100 determines the new preamble power may be expressed by Equation (5):

$${Pwr}_{new} = \{ \begin{matrix}{Pwr}_{min} & if function ( \begin{matrix}{Pwr}_{pre} , \\ {TL}_{self} , \\ {TL}_{other}\end{matrix} ) < {Pwr}_{min} \\ {Pwr}_{max} & if function ( \begin{matrix}{Pwr}_{pre} , \\ {TL}_{self} , \\ {TL}_{other}\end{matrix} ) > {Pwr}_{max} \\ & f unction ( \begin{matrix}{Pwr}_{pre} , \\ {TL}_{self} , \\ {TL}_{other}\end{matrix} ) otherwise\end{matrix} \} \qquad ( 5 )$$

where Pwrₘᵢₙ is the minimum preamble power and Pwrₘₐₓ is the maximum preamble power.

Pwr_{new}=function(Pwrₚᵣₑ,TL_{self},TLₒₜₕₑᵣ)

in Equation (5) may be rewritten as Equation (4), as described above.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in forms and details may be made therein without departing from the spirit and scope of the present invention as defined by the following claims.

### INDUSTRIAL APPLICABILITY

The present invention can be used for communication systems using orthogonal frequency division multiplexing (OFDM).

1. A method of controlling preamble power of an orthogonal frequency division multiplexing (OFDM) system including a plurality of base stations and a control station controlling the plurality of base stations, the method comprising:
detecting a present preamble power of a certain base station among the plurality of base stations and a preamble influence factor of the certain base station;
detecting a preamble influence factor of at least one neighboring base station of the certain base station; and
determining a new preamble power of the certain base station based on at least one among the present preamble power, the preamble influence factor of the certain base station, and the preamble influence factor of the at least one neighboring base station.

2. The method of claim 1, wherein at least one of the preamble influence factor of the certain base station and the preamble influence factor of the at least one neighboring base station comprises a traffic load of the corresponding base station.

3. The method of claim 1, wherein the detecting the preamble influence factor of the at least one neighboring base station of the certain base station comprises:
determining the at least one neighboring base station based on a neighboring base station list comprising information about neighboring base stations corresponding to the certain base station; and
detecting the preamble influence factor of the determined at least one neighboring base station.

4. The method of claim 3, wherein the detecting the preamble influence factor of the determined at least one neighboring base station comprises applying a predetermined weighting factor to the preamble influence factor of each of the at least one neighboring base station.

5. The method of claim 1, wherein the new preamble power of the certain base station is determined by Pwr_{new}(i)=(1−μ)·Pwrₚᵣₑ(i)+μ·Pwr_{nominal·TL}ₒₜₕₑᵣ(i)/TL_{self}(i) where Pwr_{new} is the new preamble power, Pwrₚᵣₑ is the present preamble power, Pwrₙₒₘᵢₙₐₗ is a basic preamble power, TLₒₜₕₑᵣ is a traffic load of neighboring base stations, TL_{self} is a traffic load of the certain base station, “μ” is a change sensitivity of a preamble, and “i” is an index of each base station.

6. The method of claim 5, wherein when the new preamble power is greater than a maximum power, the new preamble power of the certain base station is determined to be the maximum power and when the new preamble power is less than a minimum power, the new preamble power of the certain base station is determined to be the minimum power.

7. A computer readable recording medium for recording a program for executing the method of claim 1.

8. An orthogonal frequency division multiplexing (OFDM) system comprising:
a plurality of base stations; and
a control station configured to control preamble power of the base stations, the control station receiving a present preamble power of the certain base station and a preamble influence factor of the certain base station from the certain base station, detecting a preamble influence factor of at least one neighboring base station of the certain base station, determining a new preamble power of the certain base station based on at least one among the present preamble power, the preamble influence factor of the certain base station, and the preamble influence factor of the at least one neighboring base station, and transmitting a control signal to the certain base station.

9. The OFDM system of claim 8, wherein the control station determines the at least one neighboring base station of the certain base station based on a neighboring base station list comprising information about neighboring base stations corresponding to the certain base station and detects the preamble influence factor of the determined at least one neighboring base station.

10. The OFDM system of claim 9, wherein the control station applies a predetermined weighting factor to the preamble influence factor of each of the at least one neighboring base station and detects the preamble influence factor of the at least one neighboring base station.
